(19) United States
(12) Patent Application Publication
(10) Pub. No.: US 2026/0204083 A1
(43) Pub. Date: Jul. 16, 2026

(54) IMAGE TRANSLATION AND GENERATIVE ARTIFICIAL INTELLIGENCE OBJECT IDENTIFICATION IN AN IMAGE

(71) Applicant: Cash Map LLC, Cheyenne, WY (US)

(72) Inventors: Limarc Ambalina, Tokyo (JP); Magfurul Abeer, Staten Island, NY (US)

(21) Appl. No.: 19/405,111

(22) Filed: Dec. 1, 2025

Related U.S. Application Data
(60) Provisional application No. 63/746,145, filed on Jan. 16, 2025.

(51) Int. Cl. G06V 20/62; G06T 3/40; G06T 7/70; G06V 10/94; G06V 30/19

(52) U.S. Cl. CPC G06V 20/63; G06T 3/40; G06T 7/70; G06V 10/945; G06V 30/19; G06T 2200/24

(57) ABSTRACT

Methods, systems, and apparatus, including computer programs encoded on computer storage media for image translation and generative artificial intelligence object identification in an image. The system obtains an image in a binary file format via an application operating on a client device. The system converts the obtained image from an original binary file format to another binary file or other file format. The system generates a prompt that includes instructions for an LLM to identify objects from an input to the LLM of the converted image. An executed LLM performs the generated prompt using an input of the converted image. The system receives an output from the executed LLM that includes a generated listing of identified objects in the converted image. The system provides for display, via the user interface, at least a portion of the generated listing of the identified objects.

### CROSS-REFERENCE TO RELATED APPLICATIONS

This application claims the benefit of priority to U.S. Provisional Application No. 63/746,145, filed on January 16, 2025, which is hereby incorporated by reference in its entirety.

### FIELD

This application relates generally to configuring artificial intelligence systems, and more particularly to systems and methods for image translation and generative artificial intelligence object identification in an image.

### SUMMARY

In some embodiments, Methods, systems, and apparatus, including computer programs encoded on computer storage media for image translation and generative artificial intelligence object identification in an image. The system obtains an image in a binary file format via an application operating on a client device. The system converts the obtained image from an original binary file format to another binary file or textual file. The system generates a prompt that includes instructions for an LLM to identify objects from an input to the LLM of the converted image. An executed LLM performs the generated prompt using an input of the converted image. The system receives an output from the executed LLM that includes a generated listing of identified objects in the converted image. The system provides for display, via the user interface, at least a portion of the generated listing of the identified objects.

In some embodiments, the system performs a process to determine whether to convert an obtained binary image into another smaller binary image file or into a different bin

In some embodiments, the system performs a process to receive descriptions of items to be found and generates graphical and/or textual indications of whether a priority object was found in an image.

In some embodiments, the system performs a process to augments descriptive details from a data store or database describing multiple objects. Based on an object identified by the LLM, the system may retrieve additional data or information to be presented along with a description or listing of the identified objects.

The appended claims may serve as a summary of this application.

### BRIEF DESCRIPTION OF THE DRAWINGS

FIG. 1A is a diagram illustrating an exemplary environment in which some embodiments may operate.

FIG. 1B is a diagram illustrating an exemplary computer system with software and/or hardware modules that may execute some of the functionality described herein.

FIG. 2 is a process flow chart illustrating an exemplary method 200 that may be performed in some embodiments.

FIG. 3 is a process flow chart illustrating an exemplary method 300 that may be performed in some embodiments.

FIG. 4 is a process flow chart illustrating an exemplary method 400 that may be performed in some embodiments.

FIGS. 5A-5B are diagrams of an exemplary user interface according to some embodiments.

FIGS. 6A-6B are diagrams of an exemplary user interface according to some embodiments.

FIG. 7 is a diagram illustrating an exemplary computer that may perform processing in some embodiments.

### DETAILED DESCRIPTION OF THE DRAWINGS

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and their equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

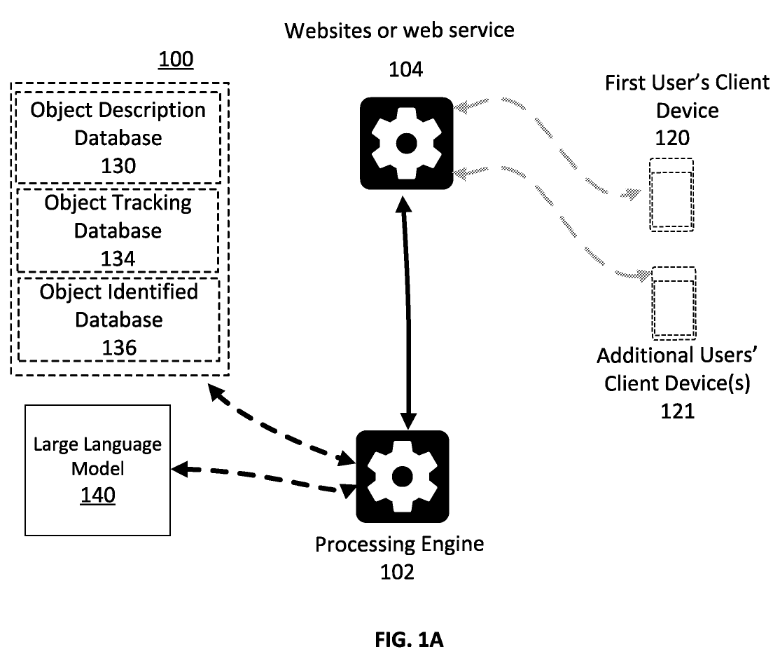

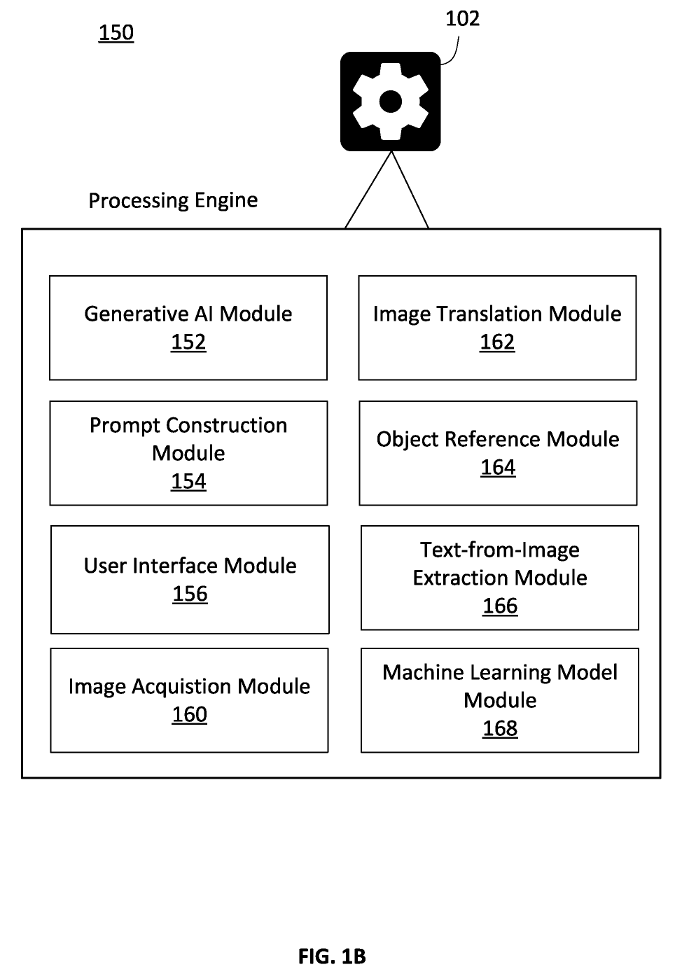

FIG. 1A is a diagram illustrating an exemplary environment in which some embodiments may operate. In the exemplary environment 100, a first user’s client device 120 and one or more additional users’ client device(s) 121 are connected to a processing engine 102. The client devices 120, 121 may interact with one or more websites (e.g., web services) running a code or a service for interaction with the processing engine 102. For example, a client device may access a first website or web service which may receive inputs form a user. These inputs may be provided directly or indirectly to the processing engine 102.

The processing engine 102 is connected to one or more machine learning models 140 (e.g., large language model) and is connected to one or more repositories (e.g., non-transitory data storage) and/or databases, including an object description database 130 (for storing and retrieving data objects with detail information about a particular object), and an object tracking database 134 (for storing and retrieving data related to one or more objects that a user is trying to locate or find).

The first user’s client device 120 and additional users’ client device(s) 121 in this environment may be computers, mobile devices, which are communicatively coupled to one or more servers operating the processing engine.

In an embodiment, processing engine 102 may perform the methods 300, 400, 500 or other methods herein and, as a result, provide interactive user interfaces used to receive user input and construct prompts for input into one or more machine learning models.

In some embodiments, the client devices 120, 121 interact directly with other online or web-based services 104. The system 100 can generate output and provide the generated output directly to the online or web-based services 104 and/or in some embodiments directly to the client devices 120, 121.

The first user’s client device 120 and additional users’ client device(s) 121 may be devices with a display configured to present information to a user of the device. In some embodiments, the first user’s client device 120 and additional users’ client device(s) 121 present information in the form of a user interface (UI) with UI elements or components. In some embodiments, the first user’s client device 120 and additional users’ client device(s) 121 send and receive signals and/or information to the processing engine 102.

In some embodiments, the first user’s client device 120 and additional users’ client device(s) 121 are computing devices capable of hosting and executing one or more applications or other programs capable of sending and/or receiving information. In some embodiments, the first user’s client device 120 and/or additional users’ client device(s) 121 may be a computer desktop or laptop, mobile phone, video phone, conferencing system, or any other suitable computing device capable of sending and receiving information.

In some embodiments, the processing engine 102 may be performed by one or more service providing services for the web service. In some embodiments, the processing engine may be performed by a respective client device 120, 121. In some embodiments, some of the modules of the processing engine may be performed by in part by a client device and in part by the web service.

FIG. 1B is a diagram illustrating an exemplary computer system 150 with software and/or hardware modules that may execute some of the functionality described herein. Computer system 150 may comprise, for example, a server or client device or a combination of server and client devices for automated configuration of software systems using images of hardware components or peripherals. The exemplary computer system 150 is shown with the processing engine 102 performing multiple modules: Machine Learning Module 152, Prompt Construction Module 154, User Interface Module 156, Image Acquisition Module 160, Image Translation Module 162, an Object Reference Module 164, a Text-from-Image Extraction Module 166 and a Machine Learning Model Module.

The Generative AI Module 152 provides system functionality for the interaction action or execution of a generative AI model (such as a large language model (LLM)). The Generative AI provides prompts to the LLM and received output from the LLM. The system may be configured to use a custom LLM or an online or Internet-based LLM service that may receive input, such an OpenAI and ChatGPT service.

The Prompt Construction Module 154 provides system functionality for the construction and formatting of prompts that are input into an LLM 140. The Prompt Construction Module 156 generates textual prompts for input to the LLM 140.

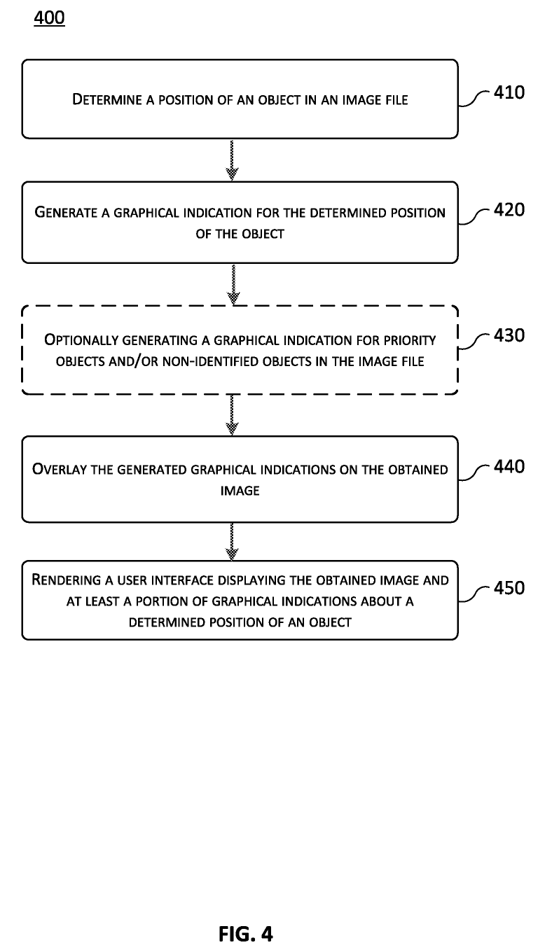

The User Interface Module 156 provides system functionality for presenting a user interface to the client devices 120, 121. Generated user interface may receive and process user input from users. User inputs received by the user interface herein may include clicks, keyboard inputs, touch inputs, taps, swipes, gestures, voice commands, activation of interface controls, and other user inputs. In some embodiments, the User Interface Module 156 generates the user interfaces depicted in FIG. 4.

The Image Acquisition Module 160 provides system functionality acquiring images. In some embodiments, the system generates the user interface depicted in FIG. 4 which is used in conjunction with obtaining images by a respective client device.

The Image Translation Module 162 provides system functionality for image translation. In some embodiments, the system generates processes images obtained by a client device. For example, an image may be translated from an image acquired by a client device from a binary format to a alphanumeric format. An image may be down sampled from an original image size to a small image size. This processing may occur, in whole or part, by the processing engine 102 on the client device and/or the web service 140.

The Object Reference Module 164 provides system functionality to retrieve additional data or descriptive details about from the Object Description Database 130.

The Text-from-Image Extraction Module 166 includes an image-to-text extraction engine that extracts text from objects depicted in images obtained by the system. The extraction engine evaluates images and identifies strings of text in the image. The module assembles the strings of text into a listing.

The Machine Learning Model Module 168 includes an engine to execute one or more machine learning models that are stored onboard the client device, and/or that are stored on a server. In some embodiments, the system may use an onboard light model to process an image to identify objects or texts in the image.

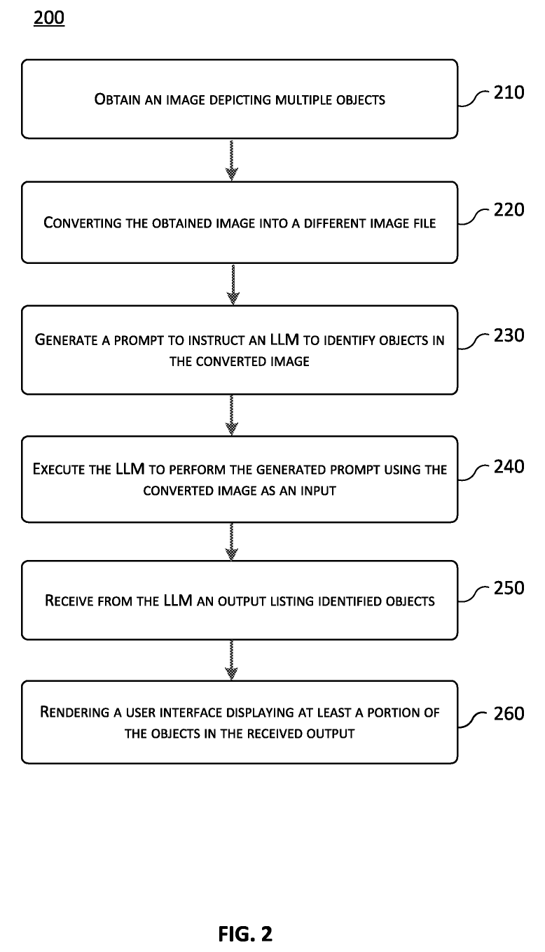

FIG. 2 is a process flow chart illustrating an exemplary method 200 that may be performed in some embodiments.

In step 210, the system obtains an image depicting multiple objects. The system obtains an image in a binary file format, via an application operating on a client device. The obtained image depicts multiple objects of the same type.

In step 220, the system determines whether the obtained image should be converted. In some embodiments, the system converts the obtained image in a binary file format into a different binary format. In some embodiments, the system converts the obtained image in a binary format into a down-sampled resolution of the obtained image. In some embodiments, the system converts the obtained image in a binary file format into a different file type of the obtained image. In some embodiments, the converted image is a different image file than the obtained image file from the client device.

In step 230, the system generates a prompt to instruct an LLM to identify objects in the converted image. In some embodiments, the system generates a textual prompt to submit to the LLM. The generated prompt includes instructions for a large language model to identify objects from an input to the LLM of the converted image.

In step 240, the system executes an LLM to perform the generated prompt using as an input, the converted image file. The system provides to the LLM the generated prompt that instructs the LLM to identify objects in the converted image file.

In step 250, the system receives an output from the LLM. In some embodiments, the received output includes a generated listing of identified objects in the converted image file.

In some embodiments, the generated prompt in step 230 includes instructions to the LLM to identify a position or location of objects in the converted image. The system receives an output the LLM where the generated listing of identified objects with an associated position in the converted image for a respective identified object.

In some embodiments, the generated prompt includes instructions for the LLM to indicate a type or category of object to be found by the LLM in the converted image.

In some embodiments, the generated prompt includes instructions for the LLM to indicate an object as an unidentified where the LLM cannot identify with a degree of certainty as to a predetermined threshold certainty value as to an object in the converted image.

In some embodiments each of the objects in the generated listing of the identified objects each have an item identifier and/or an indication that the object is not identifiable.

In some embodiments, the system determines whether an object identified in the generated listing is an object associated with a pre-defined user priority object. The system may retrieve from a database or datastore a listing of one or more objects that a user had identified as a priority or important object to find. The generating prompt may include text describing the pre-defined user priority objects with instructs to the LLM to indicate whether a priority object is among the objects in the converted image. As part of an output in the generated listing, the LLM identifies a priority object as having been found.

In step 260, the system renders a user interface that displays at least a portion of the objects in the received output from the LLM.

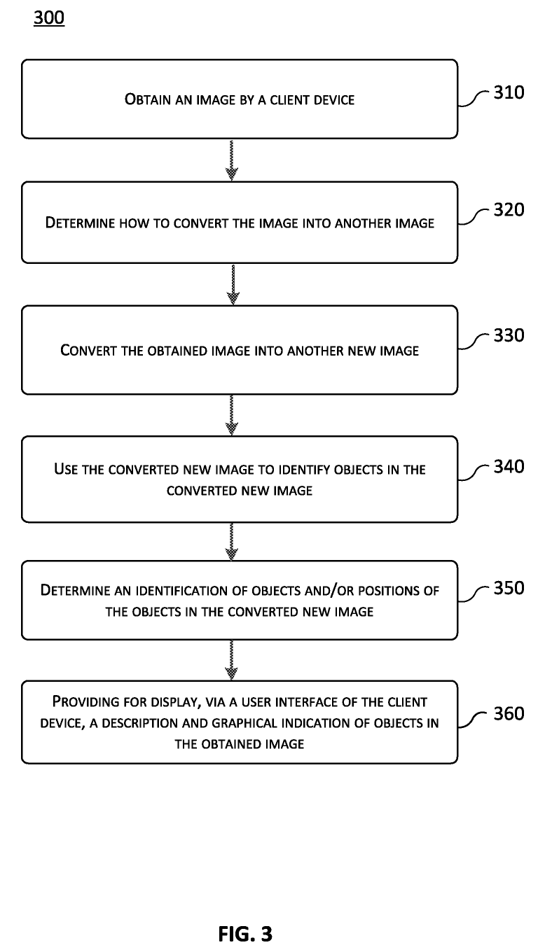

FIG. 3 is a process flow chart illustrating an exemplary method 300 that may be performed in some embodiments. The method 300 describes operations that are performed according to some embodiments to convert an obtained image into a different image file.

In step 310, a client device obtains an image. In some embodiments, the obtained image depicts multiple objects.

In step 320, the system determines whether and/or how to convert the image into another image or image format.

In step 330, the system converts the obtained image into another new image or into a new image format. In the step, the system generates a new image file based upon the obtained image file.

In some embodiments, the system determines a resolution size of the obtained image where the obtained image has a first resolution. The system down samples the obtained image from the first resolution to a second lower resolution where the first resolution exceeds a predetermined threshold resolution size.

In some embodiments, the system converts an obtained image from a first image format to a second image format, wherein the second image format is a Base64 comprising ASCII characters.

In step 340, the system uses the converted new image to identify objects in the converted new image file.

In step 350, the system determines an identification of objects and/or positions of the objects in the converted new image.

In some embodiments, the system provides a uniform resource location (URL) reference to the obtained image. In some embodiments, the URL reference is provided to the LLM, a VLM or other services for processing of the obtained image.

In step 360, the system provides for display, via a user interface of the client device, a description and graphical indication of objects in the obtained image.

FIG. 4 is a process flow chart illustrating an exemplary method 400 that may be performed in some embodiments. The method 400 describes operations that are performed according to some embodiments to determine a position of an object in a converted image file.

In some embodiments, the generated prompt in step 230 of FIG. 2 includes instructions to the LLM to identify a position or location of objects in the converted image. The system receives an output the LLM where the generated listing of identified objects with an associated position in the converted image for a respective identified object.

In step 410, the system determines a position or location of each of the objects identified in the converted image. For example, the system provides the generated prompt to the LLM as input instructing the LLM to identify a position and/or a location of an object identified by the LLM.

In some embodiments, the identified position or location of an object in the converted image comprises one or more pixel coordinates indicating the position or location of the identified object.

In step 420, the system generates a graphical indication for each of one or more objects in the converted image. For example, the system may create a bounding box or other graphical indicator based on the identified position and/or location of an object.

In step 430, the system optionally generates a graphical indication for priority objects and/or for objects not identified by the LLM in the image file.

In step 440, the system overlays the graphical indication on the obtained image.

In step 450, the system provides for display, via a user interface of a client device, the obtained image with the graphical indication for each of one or more objects identified by the LLM in the converted image.

In some embodiments, the system renders a user interface on a client device, where the user interface depicts the original obtained image along with one or graphical indications of object that were found by the LLM. In some embodiments, the user interface may also depict a priority object and/or an object not identified by the LLM.

In some embodiments, the graphical indication is any one of a bounding box, a changed pixel area as to the obtained image that indicates and/or highlights an object in the image. In some embodiments, a color and/or shape of the graphical indication is different as to a found object and an object not found by the LLM. In some embodiments, a color and/or shape of the graphical indication is different as to a found object and a priority object found by the LLM.

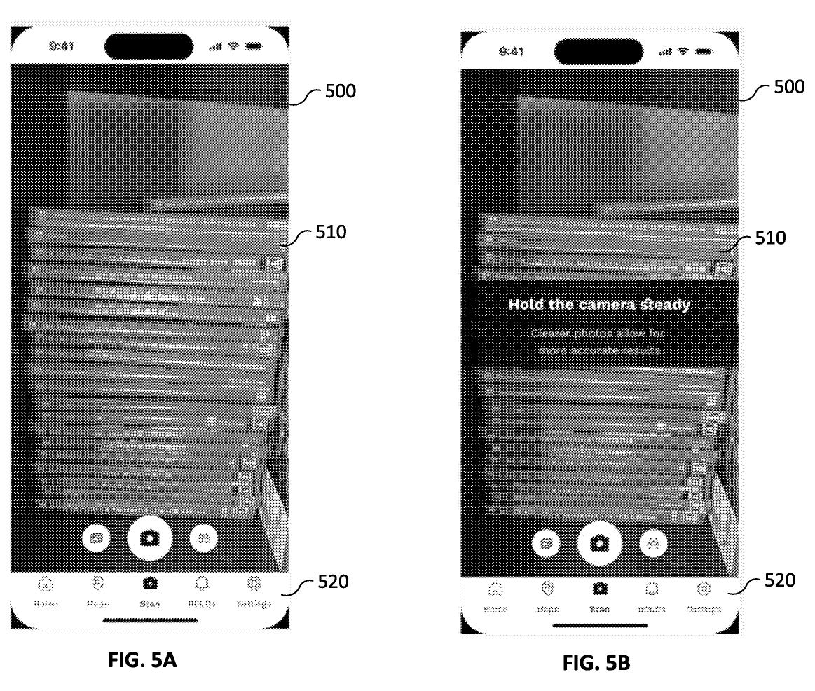

FIGS. 5A-5B are diagrams of a graphical user interface 500 illustrating functionality performed according to some embodiments.

The system generates one or more graphical user interfaces 500 that provide system functionality related to image acquisition and identifying objects identified in an obtained image. In some embodiments, the user interface provides functionality where a user may use an onboard camera of a client device to obtain one or more images of real-world objects.

In this example, FIGS. 5A-5B shows the system captures an image of a stack of different game cases 510 for different games. The user interface provides a user interface control panel 520 to scan images for items of interest to a user. The control panel also provides a user interface control to set or select priority items (item to be on the lookout, BOLO).

In some embodiments, the user interface provides functionality for receiving user input describing priority object to be found. The user interface receives textual input and or an image of an object to be found. For example, the user interface may receive a user input of particular description of an item, such as a title of a book, a title of a game, a particular name of a physical object, a game card, a description of an apparel item, etc. Later the system uses this priority object listing to annotate an LLM generated output whether an object found in an image is a priority object. The system may generate message for display, via the user interface, indicating that a priority object has been found/

In some embodiments, the system may provide instructions, via the user interface, to the user to maneuver the client device to or from a group of items to obtain better or higher resolution images that may be needed to perform text extraction from the images. For example, the system may perform a continuous process and sample a series of images an try extracting text from the image of the real-world object. If the text cannot be read off of the real-world objects in an image(such as using an optical character recognition OCR engine), then the system may generate instructions to the user to move the client device closer to the real-world objects.

In some embodiments, the system will extract text from the objects in the image and generate a listing of text. For example, the system may read the spine of the game covers and extract text form the image for each of the game covers.

In some embodiments, during the text extraction process, the system generates one or more pixel positions associated with the location for the text strings found in the image. The pixel positions may be later used by the system to assist in positioning a bounding box or other graphical identifier around or about a string of text detected in the image.

In some embodiments, the system performs a multi-step identification process using both the text extracted from an image and the image itself or a portion of the image (e.g., a pixel area or an image file) to determine objects that exist in the image.

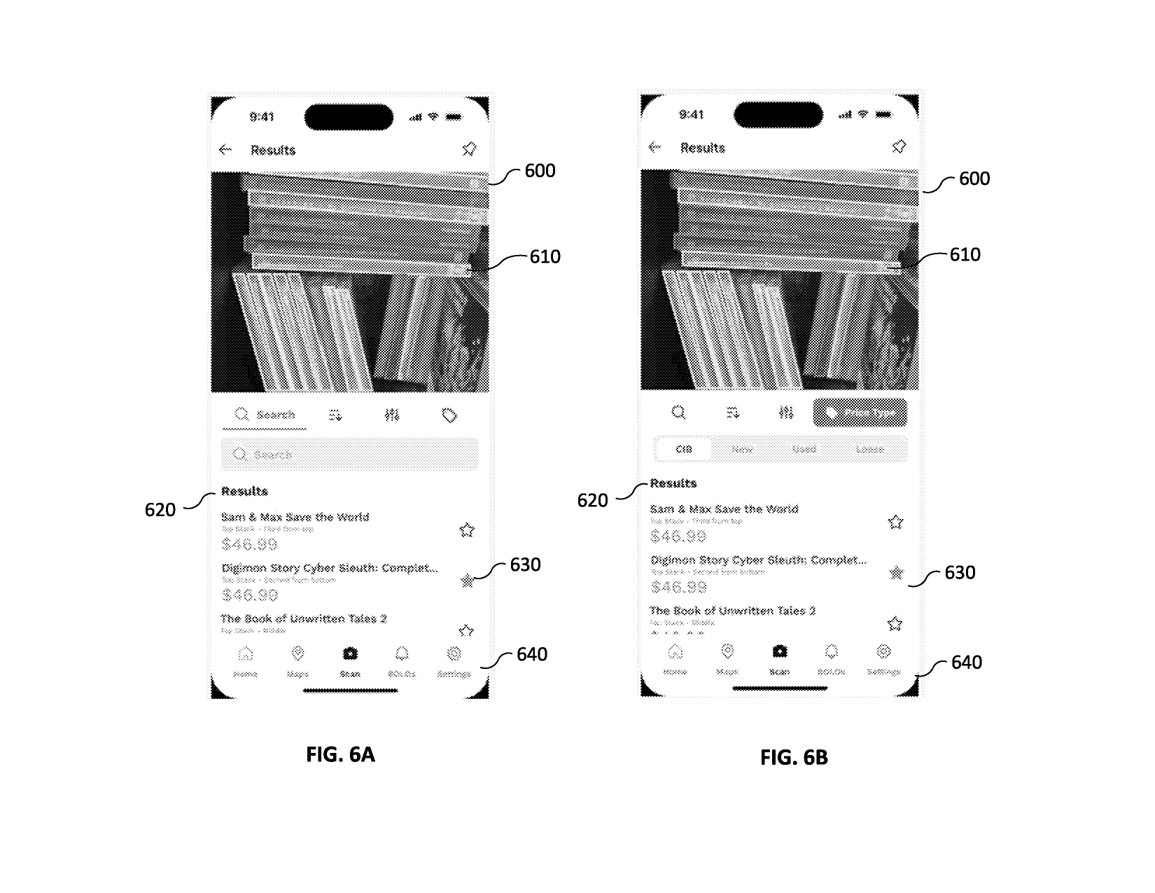

FIGS. 6A-6B are diagrams of a graphical user interface 600 illustrating functionality performed according to some embodiments.

In some embodiments, the user interface provides 600 functionality for displaying textual descriptions and/or graphical indications of objects identified in an obtained image. The graphical user interface presents a description of objects found in an image.

In some embodiments, the user interface 600 is configured with a display portion that shows at least a portion of the original obtained image. The user interface may display one or more graphical indications of objects found in an obtained image 605, 610. In some embodiments, the client device may display a composite image generated by the system where the composite image depicts objects from the obtained images with graphical indications of found objects in the image.

In some embodiments, the client device may receive pixel coordinates identifying the locations or positions of the found objects, and then dynamically draw the graphical indications, such as boundary, border, and/or a pixel change that is based on the pixel coordinates. In this example, real-world items detected in the original obtained image are displayed with graphical identifiers in the form of bounding boxes or borders placed around or about the real-world objects detected in the images. The bounding boxes, however, are displayed with different colors to indicate as attribute associated with the text found in the real-world object. For example, a first color or graphical pattern 605 may indicate that extracted text for a detected real-world object corresponds to an item found in a database or an item data store. A second color or graphical pattern 610 may indicate that extracted text for a detected real-world object could not be found in the database or the item data store.

In some embodiments, the system compares each of the extracted strings of text from the image to text in a database or data store listing BOLO items. If an extracted string of text matches, then the system may use another color or pattern to indicate that a priority item (i.e., a BOLO item) was found. The user interface and functionality a unique graphical interface to depict items that have be pre-determined as a priority item and display a graphical indication about the item in the user interface when a real-world item has been found by the system.

In some embodiments, the user interface 600 includes a textual listing of the extracted strings of text. The listing for example may include the game title of the game covers detected in the original image. The textual listing may be augmented with additional data from a database or data store, such as price details or other information. In some embodiments, the system generates a graphical indication 630 proximate to a respective listed item, where the graphical indication indicates that the listed item is a priority or BOLO item that was found by the system. For example, the user interface 600 depicts a solid star next to an item that was found by the system in the obtained image.

In some embodiments, the user interface 600 highlight a respect object in the first portion of the user interface when a particular item in the textual listing 620 is selected For example, a user may select the item referred to as “Digimon Story Cyber Sleuth:”. In response to the selection, the system will provide a graphical indication of the item in the first portion of the user interface. For example, the system may cause the border about the item to change colors, to cause an appearance of motion or movement of pixels about the item, or some other graphical indication noting the selected item from the results list 620. This allows a user then to easily identify in the real-world where that selected item is located in relationship to the other items. For example, if the Digimon Story game is a priority item for the user, the user then can easily compare the image to the real-world stack of game cases and then physically retrieve the game case from the stack for inspection.

In some embodiments, the user interface includes a user interface control that provides an input filter. For example, a user may select a sub-type of an object via the user interface. In some embodiments, the system generates the prompt for the LLM that includes a description to identify objects of the object sub-type. The executed LLM identifies the occurrence of objects in a received input corresponding to the object sub-type.

In some embodiments, the system obtains price information for identified objects and displays the price information along with the identified text of an object. In some embodiments, the system further calculates a total of price information for two or more objects and displays the total via the user interface. In some embodiments, the system counts the number of identified objects and displays a count value of the identified objects.

### Multiple Process for Object Identification and Text Extraction from an Image

In some embodiments, the system performs multiple processes for the identification of text in an obtained image depicting real-world objects. In a first process, the system uses an onboard optical character recognition engine or machine learning model to identify text in objects. The extracted listing is displayed in the user interface as described above with respect to FIGS. 5A-6B. The first process creates a listing of strings of text found in the image depicting real-world objects. All or a portion of the strings of text are listing in the user interface. Additionally, graphical indicators of the real-world objects are created and displayed over at least a portion of the obtained image.

In a second process, the system concurrently sends the image file or a small group of pixels to be evaluated by generative AI system (for example, using a large language model). In many instances, the first process may not be able to recognize text in the image. This second process may be performed asynchronously, where the image or a translation of the image is sent to an online service or a server that is remote to the client device. The server process may process the image and identify strings of text found in the image. For example, as described herein an LLM may be instructed to identify text of objects in the image. The LLM would return a result set of text of objects in the image. The resultant listing of text is transmitted to the client device. The processing engine of the client device compares the first list generated by the first process and the second listing generated by the second process to identify any new string of text (i.e., and new text for objects) that were not identified by the first process. The system then updates the listing in the user interface with the new text for objects identified in the second process.

In some embodiments, a third process may further identify that some text was not recognizable in the image the server received from the client device. The server may send a message or instructions to the client device to send a higher resolution image that was originally sent to the server. For example, a 1024 x 768 image file may have been originally sent to the server for processing, but due to the low resolution the text in the image could not be determined by the second process. In response to receiving the instructions by the client device, the client device may send (if available) a higher resolution of the image. This situation may occur where an original image was down sampled to a lower resolution by the client device and then transmitted to the server for processing. The LLM would again return another result set of text of objects in the image. The resultant listing of text is transmitted to the client device. The processing engine of the client device compares the first listing of textual strings generated by the first process and the other listing generated by the third process to identify any new strings of text (i.e., any new text for objects) that were not identified by the first process. The system then updates the listing in the user interface with the new text for objects identified in the third process.

In some embodiments, a fourth process may be performed to further identify text not recognizable in a prior received image. The user interface displays a message to the user that another close- up image or higher resolution should be taken. In response to an action taken by the user, via the user interface of the client device, to obtain a new image of the real-world objects, the obtained new image is transmitted or retrieved by the server for textual extraction of the objects in the image. The LLM would again evaluate the image or a translated image and return another result set of text of objects in the image. The resultant listing of text is transmitted to the client device. The processing engine of the client device compares the first, second and or third list to the fourth list generated by the fourth process to identify any new string of text (i.e., and new text for objects) that were not identified by the previous processes. The system then updates the listing in the user interface with the new text for objects identified in the fourth process.

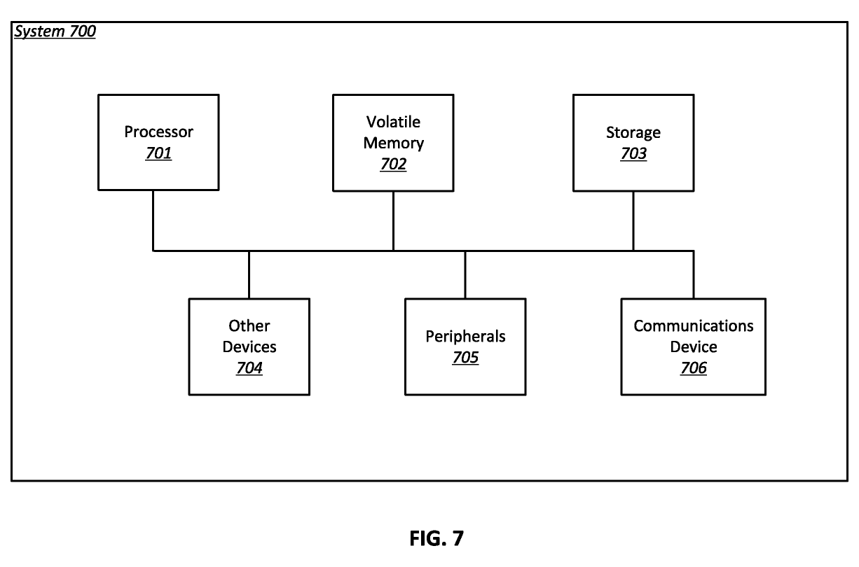

FIG. 7 is a diagram illustrating an exemplary computer 700 that may perform processing in some embodiments. Processor 701 may perform computing functions such as running computer programs. The volatile memory 702 may provide temporary storage of data for the processor 701. RAM is one kind of volatile memory. Volatile memory typically requires power to maintain its stored information. Storage 703 provides computer storage for data, instructions, and/or arbitrary information. Non-volatile memory, which can preserve data even when not powered and including disks and flash memory, is an example of storage. Storage 703 may be organized as a file system, database, or in other ways. Data, instructions, and information may be loaded from storage 703 into volatile memory 702 for processing by the processor 701.

The computer 700 may include peripherals 705. Peripherals 705 may include input peripherals such as a keyboard, mouse, trackball, video camera, microphone, and other input devices. Peripherals 705 may also include output devices such as a display. Communications device 706 may connect the computer 700 to an external medium. For example, communications device 706 may take the form of a network adapter that provides communications to a network. A computer 700 may also include a variety of other devices 704. The various components of the computer 700 may be connected by a connection medium such as a bus, crossbar, or network.

It will be appreciated that the present disclosure may include any one and up to all of the following examples.

Example 1. A computer-implemented method comprising: obtaining an image in a binary file format, via an application operating on a client device, wherein the obtained image depicts multiple objects of the same type; determining that the obtained image should be converted, and converting the obtained image in the binary file format into a different binary format, into a down-sampled resolution of the obtained image and/or into a different file type of the obtained image; generating a prompt, wherein the prompt includes instructions for a large language model to identify objects from an input to the LLM of the converted image; executing an LLM to perform the generated prompt using an input of the converted image file; receiving an output from the LLM, the output comprising a generated listing of identified objects in the converted image file; and providing for display, via the user interface, at least a portion of the generated listing of the identified objects, wherein the user interface includes a user interface section listing a textual description of the identified objects.

Example 2. The computer-implemented method of Example 1, further comprising: receiving, via the user interface, an input indicating a filter, the filter describing an object sub-type, wherein the generated prompt includes a description to identify objects of the object sub-type; wherein the executed LLM identifies the occurrence of objects in a received input corresponding to the object sub-type; and wherein each of the objects in the generated listing of the identified objects each having an item identifier and/or an indication that the object is not identifiable.

Example 3. The computer-implemented method of any one of Examples 1-2, further comprising: determining whether an object identified in the generated listing is an object associated with a pre-defined user priority object.

Example 4. The computer-implemented method of any one of Examples 1-3, further comprising the operations of: determining a location of each of the objects identified in the converted image; generating a graphical indication for each of one or more objects in the converted image; overlaying the graphical indication on the obtained image; and providing for display, via the user interface, the obtained image with the graphical indication for each of one or more objects in the converted image.

Example 5. The computer-implemented method of any one of Examples 1-4, wherein converting the image file comprises: determining a resolution size of the obtained image, wherein the obtained image has a first resolution; and down sampling the obtained image s from the first resolution to a second lower resolution where the first resolution exceeds a predetermined threshold resolution size.

Example 6. The computer-implemented method of any one of Examples 1-5, wherein converting the image file comprises: converting the one or more images from a first image format to a second image format, wherein the second image format is a Base64 comprising ASCII characters.

Example 7. The computer-implemented method of any one of Examples 1-6, further comprising the operations of: determining a location of each of the identified objects in the one or more images; and displaying, via the user interface, the obtained image, and a graphical location indicator proximate to each of the identified objects.

Example 8. The computer-implemented method of any one of Examples 1-7, further comprising the operations of: wherein the generated prompt includes instructions to the LLM to identify a position of objects in the converted image; receiving, an output from the generative AI system, the output comprising the generated listing of identified objects with an associated position in the converted image for a respective identified object; and generating the graphical location indicator based on the identified position of each object.

Example 9. The computer-implemented method of any one of Examples 1-8, wherein the identified position of an object in the converted image comprises one or more pixel coordinates indicating the position of the object.

Example 10. The computer-implemented method of any one of Examples 1-9, wherein converting the image file comprises: determining an area in the obtained image; and generating the converted image by removing pixels outside of the determined area.

Example 11. The computer-implemented method of any one of Examples 1-10, further comprising: requesting, as part of the generated prompt, the LLM to indicate an object as an unidentified where the LLM cannot identify with a degree of certainty as to a predetermined threshold certainty value, the type of the object; and providing for display, via the user interface, an indication that one or more objects were not identifiable.

Example 12. The computer-implemented method of any one of Examples 1-11, further comprising: determining a position of each of the unidentified objects in the converted image; and displaying, via the user interface, a graphical location indicator proximate to each of the unidentified objects.

Example 13. The computer-implemented method of any one of Examples 1-12, further comprising: determining whether the generated listing includes identified objects, and searching a database for data associated with the identified objects; augmented description information from the database to the identified objects; and providing for display, via the user interface, the augmented descriptive information along with the listing of the textual description of the identified objections.

Example 14. A system comprising one or more processors configured to perform the operations of: obtaining an image in a binary file format, via an application operating on a client device, wherein the obtained image depicts multiple objects of the same type; determining that the obtained image should be converted, and converting the obtained image in the binary file format into a different binary format, into a down-sampled resolution of the obtained image and/or into a different file type of the obtained image; generating a prompt, wherein the prompt includes instructions for a large language model to identify objects from an input to the LLM of the converted image; executing an LLM to perform the generated prompt using an input of the converted image file; receiving an output from the LLM, the output comprising a generated listing of identified objects in the converted image file; and providing for display, via the user interface, at least a portion of the generated listing of the identified objects, wherein the user interface includes a user interface section listing a textual description of the identified objects.

Example 15. The system of Example 14, further comprising the operations of: receiving, via the user interface, an input indicating a filter, the filter describing an object sub-type, wherein the generated prompt includes a description to identify objects of the object sub-type; wherein the executed LLM identifies the occurrence of objects in a received input

corresponding to the object sub-type; and wherein each of the objects in the generated listing of the identified objects each having an item identifier and/or an indication that the object is not identifiable.

Example 16. The system of any one of Examples 14-15, further comprising the operations of: determining whether an object identified in the generated listing is an object associated with a pre-defined user priority object.

Example 17. The system of any one of Examples 14-15, further comprising the operations of: determining a location of each of the objects identified in the converted image; generating a graphical indication for each of one or more objects in the converted image; overlaying the graphical indication on the obtained image; and providing for display, via the user interface, the obtained image with the graphical indication for each of one or more objects in the converted image.

Example 18. The system of any one of Examples 14-15, wherein converting the image file comprises: determining a resolution size of the obtained image, wherein the obtained image has a first resolution; and down sampling the obtained image s from the first resolution to a second lower resolution where the first resolution exceeds a predetermined threshold resolution size.

Example 19. The system of any one of Examples 14-15, wherein converting the image file comprises: converting the one or more images from a first image format to a second image format, wherein the second image format is a Base64 comprising ASCII characters.

Example 20. The system of any one of Examples 14-15, further comprising the operations of: determining a location of each of the identified objects in the one or more images; and displaying, via the user interface, the obtained image, and a graphical location indicator proximate to each of the identified objects.

Example 21. The system of any one of Examples 14-15, further comprising the operations of: wherein the generated prompt includes instructions to the LLM to identify a position of objects in the converted image; receiving, an output from the generative AI system, the output comprising the generated listing of identified objects with an associated position in the converted image for a respective identified object; and generating the graphical location indicator based on the identified position of each object.

Example 22. The system of any one of Examples 14-15, wherein the identified position of an object in the converted image comprises one or more pixel coordinates indicating the position of the object.

Example 23. The system of any one of Examples 14-15, wherein converting the image file comprises: determining an area in the obtained image; and generating the converted image by removing pixels outside of the determined area.

Example 24. The system of any one of Examples 14-15, further comprising the operations: requesting, as part of the generated prompt, the LLM to indicate an object as an unidentified where the LLM cannot identify with a degree of certainty as to a predetermined threshold certainty value, the type of the object; and providing for display, via the user interface, an indication that one or more objects were not identifiable.

Example 25. The system of any one of Examples 14-15, further comprising the operations of: determining a position of each of the unidentified objects in the converted image; and displaying, via the user interface, a graphical location indicator proximate to each of the unidentified objects.

Example 26. The system of claim 24, further comprising the operations of determining whether the generated listing includes identified objects, and searching a database for data associated with the identified objects; augmented description information from the database to the identified objects; and providing for display, via the user interface, the augmented descriptive information along with the listing of the textual description of the identified objections.

Some portions of the preceding detailed descriptions have been presented in terms of processes, functions and/or symbolic representations of operations on data bits within a computer memory. These algorithmic and/or equation descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method comprising the operations of:
obtaining an image in a binary file format, via an application operating on a client device, wherein the obtained image depicts multiple objects of the same type;
determining that the obtained image should be converted, and converting the obtained image in the binary file format into a different binary format, into a down-sampled resolution of the obtained image and/or into a different file type of the obtained image;
generating a prompt, wherein the prompt includes instructions for a large language model to identify objects from an input to the LLM of the converted image;
executing an LLM to perform the generated prompt using an input of the converted image file;
receiving an output from the LLM, the output comprising a generated listing of identified objects in the converted image file; and
providing for display, via the user interface, at least a portion of the generated listing of the identified objects, wherein the user interface includes a user interface section listing a textual description of the identified objects.

2. The computer-implemented method of claim 1, further comprising the operations of:
receiving, via the user interface, an input indicating a filter, the filter describing an object sub-type, wherein the generated prompt includes a description to identify objects of the object sub-type;
wherein the executed LLM identifies the occurrence of objects in a received input corresponding to the object sub-type; and
wherein each of the objects in the generated listing of the identified objects each having an item identifier and/or an indication that the object is not identifiable.

3. The computer-implemented method of claim 1, further comprising the operations of:
determining whether an object identified in the generated listing is an object associated with a pre-defined user priority object.

4. The computer-implemented method of claim 1, further comprising the operations of:
determining a location of each of the objects identified in the converted image;
generating a graphical indication for each of one or more objects in the converted image;
overlaying the graphical indication on the obtained image; and
providing for display, via the user interface, the obtained image with the graphical indication for each of one or more objects in the converted image.

5. The computer-implemented method of claim 1, wherein converting the image file comprises:
determining a resolution size of the obtained image, wherein the obtained image has a first resolution; and
down sampling the obtained image s from the first resolution to a second lower resolution where the first resolution exceeds a predetermined threshold resolution size.

6. The computer-implemented method of claim 1, wherein converting the image file comprises:
converting the one or more images from a first image format to a second image format, wherein the second image format is a Base64 comprising ASCII characters.

7. The computer-implemented method of claim 1, further comprising the operations of:
determining a location of each of the identified objects in the one or more images; and
displaying, via the user interface, the obtained image, and a graphical location indicator proximate to each of the identified objects.

8. The computer-implemented method of claim 7, further comprising the operations of:
wherein the generated prompt includes instructions to the LLM to identify a position of objects in the converted image;
receiving, an output from the generative AI system, the output comprising the generated listing of identified objects with an associated position in the converted image for a respective identified object; and
generating the graphical location indicator based on the identified position of each object.

9. The computer-implemented method of claim 8, wherein the identified position of an object in the converted image comprises one or more pixel coordinates indicating the position of the object.

10. The computer-implemented method of claim 1, wherein converting the image file comprises:
determining an area in the obtained image; and
generating the converted image by removing pixels outside of the determined area.

11. The computer-implemented method of claim 1, further comprising the operations of:
requesting, as part of the generated prompt, the LLM to indicate an object as an unidentified where the LLM can not identify with a degree of certainty as to a predetermined threshold certainty value, the type of the object; and
providing for display, via the user interface, an indication that one or more objects were not identifiable.

12. The computer-implemented method of claim 11, further comprising the operations of:
determining a position of each of the unidentified objects in the converted image; and
displaying, via the user interface, a graphical location indicator proximate to each of the unidentified objects.

13. The computer-implemented method of claim 11, further comprising the operations of:
determining whether the generated listing includes identified objects, and searching a database for data associated with the identified objects;
augmented description information from the database to the identified objects; and
providing for display, via the user interface, the augmented descriptive information along with the listing of the textual description of the identified objections.

14. A system comprising one or more processors configured to perform the operations of:
obtaining an image in a binary file format, via an application operating on a client device, wherein the obtained image depicts multiple objects of the same type;
determining that the obtained image should be converted, and converting the obtained image in the binary file format into a different binary format, into a down-sampled resolution of the obtained image and/or into a different file type of the obtained image;
generating a prompt, wherein the prompt includes instructions for a large language model to identify objects from an input to the LLM of the converted image;
executing an LLM to perform the generated prompt using an input of the converted image file;
receiving an output from the LLM, the output comprising a generated listing of identified objects in the converted image file; and
providing for display, via the user interface, at least a portion of the generated listing of the identified objects, wherein the user interface includes a user interface section listing a textual description of the identified objects.

15. The system of claim 14, further comprising the operations of:
receiving, via the user interface, an input indicating a filter, the filter describing an object sub-type, wherein the generated prompt includes a description to identify objects of the object sub-type;
wherein the executed LLM identifies the occurrence of objects in a received input corresponding to the object sub-type; and
wherein each of the objects in the generated listing of the identified objects each having an item identifier and/or an indication that the object is not identifiable.

16. The system of claim 14, further comprising the operations of:
determining whether an object identified in the generated listing is an object associated with a pre-defined user priority object.

17. The system of claim 14, further comprising the operations of:
determining a location of each of the objects identified in the converted image;
generating a graphical indication for each of one or more objects in the converted image;
overlaying the graphical indication on the obtained image; and
providing for display, via the user interface, the obtained image with the graphical indication for each of one or more objects in the converted image.

18. The system of claim 14, wherein converting the image file comprises:
determining a resolution size of the obtained image, wherein the obtained image has a first resolution; and
down sampling the obtained image s from the first resolution to a second lower resolution where the first resolution exceeds a predetermined threshold resolution size.

19. The system of claim 14, wherein converting the image file comprises:
converting the one or more images from a first image format to a second image format, wherein the second image format is a Base64 comprising ASCII characters.

20. The system of claim 14, further comprising the operations of:
determining a location of each of the identified objects in the one or more images; and
displaying, via the user interface, the obtained image, and a graphical location indicator proximate to each of the identified objects.

21. The system of claim 20, further comprising the operations of:
wherein the generated prompt includes instructions to the LLM to identify a position of objects in the converted image;
receiving, an output from the generative AI system, the output comprising the generated listing of identified objects with an associated position in the converted image for a respective identified object; and
generating the graphical location indicator based on the identified position of each object.

22. The system of claim 21, wherein the identified position of an object in the converted image comprises one or more pixel coordinates indicating the position of the object.

23. The system of claim 14, wherein converting the image file comprises:
determining an area in the obtained image; and
generating the converted image by removing pixels outside of the determined area.

24. The system of claim 14, further comprising the operations:
requesting, as part of the generated prompt, the LLM to indicate an object as an unidentified where the LLM can not identify with a degree of certainty as to a predetermined threshold certainty value, the type of the object; and
providing for display, via the user interface, an indication that one or more objects were not identifiable.

25. The system of claim 24, further comprising the operations of:
determining a position of each of the unidentified objects in the converted image; and
displaying, via the user interface, a graphical location indicator proximate to each of the unidentified objects.

26. The system of claim 24, further comprising the operations of:
determining whether the generated listing includes identified objects, and searching a database for data associated with the identified objects;
augmented description information from the database to the identified objects; and
providing for display, via the user interface, the augmented descriptive information along with the listing of the textual description of the identified objections.
